(19) United States
(12) Patent Application Publication
(10) Pub. No.: US 2014/0344423 A1
(43) Pub. Date: Nov. 20, 2014

(54) METHOD, APPARATUS AND SYSTEM FOR SWITCHING FUNCTION MODE

(71) Applicant: TENCENT TECHNOLOGY (SHENZHEN) COMPANY LIMITED, Shenzhen (CN)

(72) Inventors: SUNBI YU, Shenzhen (CN); DECONG PING, Shenzhen (CN)

(73) Assignee: TENCENT TECHNOLOGY (SHENZHEN) COMPANY LIMITED, Shenzhen (CN)

(21) Appl. No.: 14/243,078

(22) Filed: Apr. 2, 2014

Related U.S. Application Data
(63) Continuation of application No. PCT/CN2013/089886, filed on Dec. 18, 2013.

(30) Foreign Application Priority Data
May 16, 2013 (CN) 2013101813993

(51) Int. Cl. H04L 12/24

(52) U.S. Cl. CPC H04L 41/0813
USPC 709/221

(57) ABSTRACT

Methods, apparatus, and systems for switching a function mode are provided herein. In an exemplary method, a server stays connected with each of a first-type client and a second-type client via a channel, the each of the first-type client and the second-type client having a function-mode-display interface being displayed thereon. A switching request is received from the first-type client via the channel, the switching request including a first-type client identifier and a target-function-mode identifier. After obtaining a second-type client identifier corresponding to the first-type client identifier according to a preset group relationship, the corresponding second-type client is obtained. A function-mode-configuration parameter corresponding to the target-function-mode identifier is obtained according to a preset function-mode list. The function-mode-configuration parameter is sent to the first-type client and the second-type client via the channel, such that the first-type client and the second-type client update the function-mode-display interface according to the function-mode-configuration parameter.

### CROSS-REFERENCES TO RELATED APPLICATIONS

This application is a continuation application of PCT Patent Application No. PCT/CN2013/089886, filed on Dec. 18, 2013, which claims priority to Chinese Patent Application No. 201310181399.3, filed on May 16, 2013, the entire contents of all of which are incorporated herein by reference.

### FIELD OF THE DISCLOSURE

The present disclosure generally relates to networking connection technology and, more particularly, relates to methods, apparatus, and systems for switching function mode.

### BACKGROUND

With development of software technology, user demand for software functionality increases continuously. One software program can usually provide users with a variety of different functions. In other words, one software program has a variety of function modes for users to use. Thus, there arises a need for a user to directly switch from one function mode to another function mode of the same software program.

Conventionally, the function modes can be switched using the following steps. First, an original connection channel between a client and a server is disconnected. Next, a new connection channel is established between the client and server. Finally, via the new connection channel, the client sends a function mode switching request to the server to switch the function mode accordingly.

When a large number of clients send function mode switching requests to the server via newly-established connection channels in order to complete the function mode switching, because there are a large number of requests sent to the server at a same time, congestion can occur during client-server interactions. Thus, server performance may be reduced. Meanwhile, re-establishing the connection channel in order to complete the function mode switching can result in low efficiency of function mode switching for the user, and the user may need to wait a relatively long time for the switching.

### BRIEF SUMMARY OF THE DISCLOSURE

One aspect of the present disclosure includes a method for switching a function mode. An exemplary method can be implemented by a computer system. The computer system can stay connected with each of a first-type client and a second-type client via a channel. The each of the first-type client and the second-type client can have a function-mode-display interface being displayed thereon. A switching request for a target function mode can be received from the first-type client via the channel. The switching request can include a first-type client identifier and a target-function-mode identifier. A second-type client identifier corresponding to the first-type client identifier can be obtained according to a preset group relationship. The preset group relationship can include a correspondence relationship between the first-type client identifier and the second-type client identifier. The second-type client corresponding to the second-type client identifier can be obtained. A function-mode-configuration parameter corresponding to the target-function-mode identifier can be obtained according to a preset function-mode list. The preset function-mode list can include a correspondence relationship between the target-function-mode identifier and the function-mode-configuration parameter. The function-mode-configuration parameter can be sent to the each of the first-type client and the second-type client via the channel, such that the each of the first-type client and the second-type client can update the function-mode-display interface according to the function-mode-configuration parameter.

Another aspect of the present disclosure includes an apparatus for switching a function mode. An exemplary apparatus can include a connection module, a first receiving module, a first obtaining module, a second obtaining module, and a sending module. The connection module can be configured to stay connected with each of a first-type client and a second-type client via a channel. The each of the first-type client and the second-type client can have a function-mode-display interface being displayed thereon. The first receiving module can be configured to receive a switching request for a target function mode from the first-type client via the channel. The switching request can include a first-type client identifier and a target-function-mode identifier. The first obtaining module can be configured to obtain a second-type client identifier corresponding to the first-type client identifier according to a preset group relationship. The preset group relationship can include a correspondence relationship between the first-type client identifier and the second-type client identifier. The first obtaining module can further be configured to obtain the second-type client corresponding to the second-type client identifier. The second obtaining module can be configured to obtain a function-mode-configuration parameter corresponding to the target-function-mode identifier according to a preset function-mode list. The preset function-mode list can include a correspondence relationship between the target-function-mode identifier and the function-mode-configuration parameter. The sending module can be configured to send the function-mode-configuration parameter to the each of the first-type client and the second-type client via the channel, such that the each of the first-type client and the second-type client can update the function-mode-display interface according to the function-mode-configuration parameter.

Another aspect of the present disclosure includes a system for switching a function mode. An exemplary system can include a server staying connected with each of a first-type client and a second-type client via a channel. The each of the first-type client and the second-type client can have a function-mode-display interface being displayed thereon. The server can be configured to receive a switching request for a target function mode from the first-type client via the channel. The switching request can include a first-type client identifier and a target-function-mode identifier. The server can be configured to obtain a second-type client identifier corresponding to the first-type client identifier according to a preset group relationship. The preset group relationship can include a correspondence relationship between the first-type client identifier and the second-type client identifier. The server can be configured to obtain the second-type client corresponding to the second-type client identifier. The server can further be configured to obtain a function-mode-configuration parameter corresponding to the target-function-mode identifier according to a preset function-mode list. The preset function-mode list can include a correspondence relationship between the target-function-mode identifier and the function-mode-configuration parameter. The server can further be configured to send the function-mode-configuration parameter to the each of the first-type client and the second-type client via the channel, such that the each of the first-type client and the second-type client can update the function-mode-display interface according to the function-mode-configuration parameter.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the disclosure.

FIG. 1 depicts a flow diagram of an exemplary method for switching function mode in accordance with various disclosed embodiments;

FIG. 2 depicts a flow diagram of another exemplary method for switching function mode including a verification step in accordance with various disclosed embodiments;

FIG. 3 depicts an exemplary interface illustrating an administrator initiating a function mode switching request in accordance with various disclosed embodiments;

FIG. 4 depicts an exemplary waiting interface during a process of switching function mode in accordance with various disclosed embodiments;

FIG. 5 depicts an exemplary function-mode-display interface after successfully switching function mode in accordance with various disclosed embodiments;

FIG. 6 depicts a structure diagram of an exemplary apparatus for switching function mode in accordance with various disclosed embodiments;

FIG. 7 depicts a structure diagram of another exemplary apparatus for switching function mode including a verification function in accordance with various disclosed embodiments;

FIG. 8 depicts a structure diagram of an exemplary system for switching function mode in accordance with various disclosed embodiments; and

FIG. 9 depicts a structure diagram of an exemplary computer system in accordance with various disclosed embodiments.

### DETAILED DESCRIPTION

Reference will now be made in detail to exemplary embodiments of the disclosure, which are illustrated in the accompanying drawings.

In order to meet a user's need to switch from one function mode to another function mode using the same software program, various embodiments provide methods, apparatus, and systems for switching function mode. There is no need to re-establish a connection channel. Switching of function mode can be accomplished based on an original connection channel. Thus, efficiency of switching function mode can be improved, and user's waiting time for the switching can be reduced.

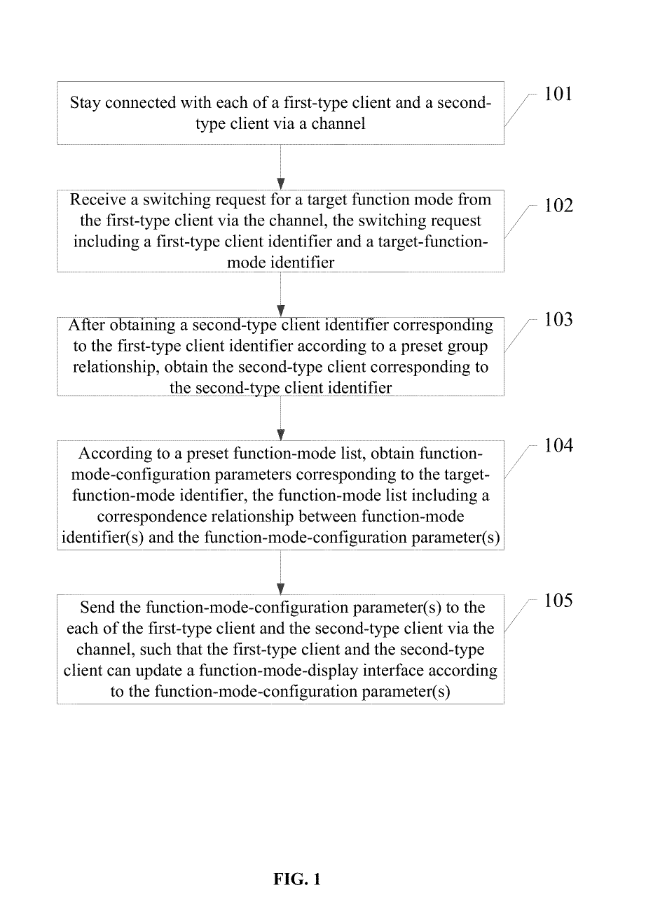

FIG. 1 depicts a flow diagram of an exemplary method for switching function mode in accordance with various disclosed embodiments. In various embodiments, the exemplary method can be implemented by a computer system including, e.g., a server. The method can include the following exemplary steps.

In Step 101, the computer system stays connected with each of a first-type client and a second-type client via a channel. In various embodiments, a server can stay connected with the first-type client and the second-type client via the channel. The server can stay connected with the first-type client and the second-type client via a same or different channel, without limitation. For example, the first-type client can include an administrator client, and the second-type client can include a general user client. The first-type client and the second-type client can both be connected to the server. At the same time, the connecting can be via the channel. The channel can include, e.g., a socket connection. As used herein, unless otherwise specified, a ‘channel’ can be used interchangeably with a ‘connection channel’.

In some cases, a client can refer to any suitable software programs for performing certain actions (e.g., game, voice/text communication, etc.). One or more clients can be implemented on a terminal. A terminal, as used herein, may refer to any appropriate terminal device with certain computing capabilities, e.g., a personal computer (PC), a work station computer, a hand-held computing device (e.g., a tablet), a mobile terminal (e.g., a mobile phone or a smart phone), or any other client-side computing device. In other cases, a client may refer to a client device having a terminal installed with suitable software programs.

In Step 102, a switching request for a target function mode is received from the first-type client via the channel. The switching request can include a first-type client identifier and a target-function-mode identifier. In various embodiments, a switching request can refer to a request for switching function mode. In certain cases, ‘switching function mode’, or ‘switching a function mode’, can refer to switching from a current function mode to a target function mode.

In one embodiment, a switching request can be received via the channel (i.e., an original channel). The switching request can be a switching request for a target function mode. At the same time, the switching request can include a first-type client identifier and a target-function-mode identifier. The first-type client identifier can be used to uniquely identify the first-type client. A function-mode identifier can be used to uniquely identify a function mode. Accordingly, the target-function-mode identifier can be used to uniquely identify the target function mode.

In addition, the first-type client identifier can be an instant messaging number including, e.g., QQ number (QQ is a software program developed by Tencent Holdings Limited, located in Shenzhen, China), user name of an e-mail, etc. Specific forms of identifier are not limited in the present disclosure.

In Step 103, after obtaining a second-type client identifier corresponding to the first-type client identifier according to a preset group relationship, the second-type client corresponding to the second-type client identifier is obtained. The preset group relationship can include a correspondence relationship between the first-type client identifier and the second-type client identifier.

In various embodiments, after the first-type client identifier in the switching request is obtained, the second-type client identifier corresponding to the first-type client identifier can be inquired in the preset group relationship, according to the first-type client identifier. The second-type client identifier can then be used to uniquely identify the second-type client. Further, after the second-type client identifier is obtained, the second-type client corresponding to the second-type client identifier can be obtained. That is, the second-type client can be uniquely determined according to the second-type client identifier.

In various embodiments, before switching the function mode, the group relationship can be set first. The group relationship can include a correspondence relationship between the first-type client identifier and the second-type client identifier. The first-type client identifier and the second-type client identifier can be used to uniquely identify the first-type client and the second-type client, respectively. For example, the group relationship may indicate a correspondence relationship between an administrator client and a general user client. In various embodiments, a first-type client identifier can have correspondence relationships respectively with multiple second-type client identifiers, and vise versa. For example, the administrator client can correspond to multiple general user clients.

In addition, for example, the group relationship can be understood using a concept of a ‘room’ in certain group-chat software program. A room can be formed by correspondence relationship(s), e.g., relationship(s)) between an administrator and user(s). Similarly, the group relationship can be formed by correspondence relationship(s) between the first-type client identifier(s) and the second-type client identifier(s). In practical applications, the group relationship can be stored in the form of a table or any other suitable forms, without limitation.

In Step 104, according to a preset function-mode list, function-mode-configuration parameter(s) (or function-mode parameters) corresponding to the target-function-mode identifier are obtained. The function-mode list can include a correspondence relationship between a function-mode identifier and the function-mode-configuration parameter(s).

In various embodiments, after the target-function-mode identifier in the switching request is obtained, the function-mode-configuration parameter(s) corresponding to the target-function-mode identifier can be inquired in the preset function-mode list. The function-mode-configuration parameter(s) corresponding to the group relationship can then be reset to be the function-mode-configuration parameters obtained (i.e., obtained by the inquiry). The function-mode list can include a correspondence relationship between a function-mode identifier and the function-mode-configuration parameter(s). For example, the function-mode list can include a correspondence relationship between the target-function-mode identifier and the function-mode-configuration parameter(s) of the target function mode. In various embodiments, different function modes can have different function-mode-configuration parameters. For example, each function mode can have certain function-mode-configuration parameter(s) correspondingly. When the function mode is switched, the function-mode-configuration parameters are changed accordingly.

In various embodiments, before switching the function mode, the function-mode list can be set first. The function-mode list can include a correspondence relationship between a function-mode identifier and function-mode-configuration parameter(s). A function-mode identifier can be used to uniquely identify a function mode. The function-mode-configuration parameters can include any suitable parameters to accomplish the switching of function mode to enter a target function mode, without limitation. In practical applications, the function-mode list can be stored in the form of a table or any other suitable forms, without limitation.

In Step 105, the function-mode-configuration parameters are sent to the first-type client and the second-type client via the channel, such that the first-type client and the second-type client can update a function-mode-display interface according to the function-mode-configuration parameters.

In one embodiment, after the function-mode-configuration parameters of the target function mode are obtained, the function-mode-configuration parameters of the target function mode can be sent to the first-type client and the second-type client via the original channel. After the first-type client and the second-type client receive the function-mode-configuration parameters, the function-mode-display interface can be updated according to the function-mode-configuration parameters. As used herein, the function-mode-configuration parameters of the target function mode can also be referred as the target-function-mode parameters.

After being updated on the first-type client and the second-type client, the function-mode-display interface can be displayed in any suitable form, without limitation. In various embodiments, different function modes can correspond to different function-mode-display interfaces, respectively. After the user switches the function mode, the function-mode-display interface can be changed accordingly. For example, under a current function mode, a function-mode-display interface corresponding to the current function mode can be displayed. After switching to the target function mode, the function-mode-display interface can be updated and become a function-mode-display interface corresponding to the target mode, to be displayed accordingly.

In practical applications, in order to prevent illegitimate users from switching function mode illegitimately and to ensure security of switching function mode, more step(s) can be included to verify the first-type client identifier that sends the switching request. For example, the step(s) can be as follows.

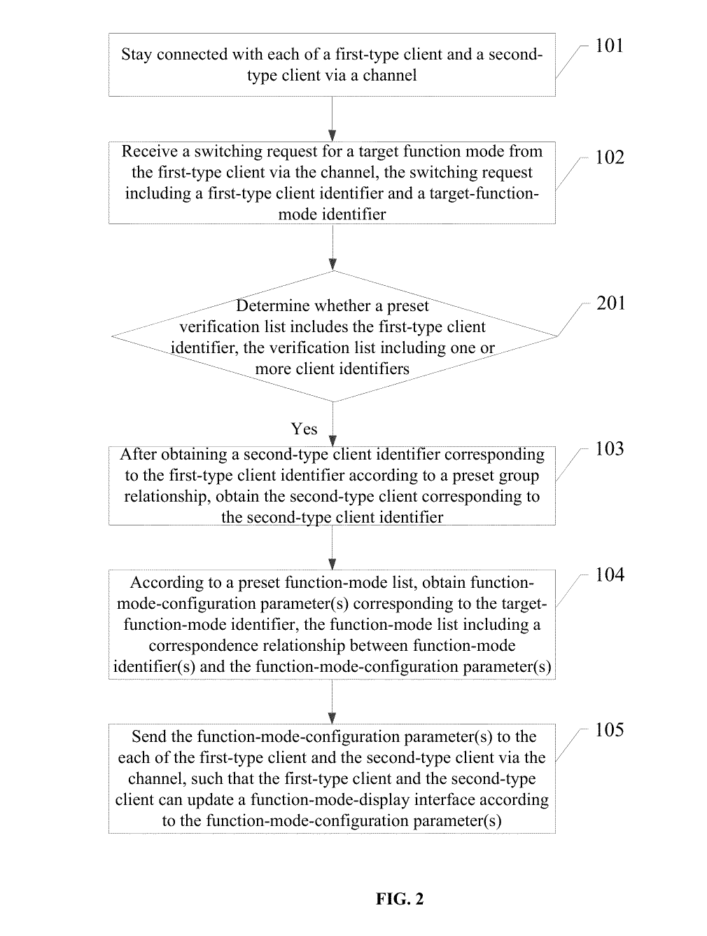

FIG. 2 depicts a flow diagram of another exemplary method for switching function mode including a verification step in accordance with various disclosed embodiments. For example, between Steps 102 and 103, Step 201 can be included.

In Step 201, it is determined whether a preset verification list includes the first-type client identifier. The verification list can include one or more client identifiers. When the verification list includes the first-type client identifier, Step 103 can be performed.

In one embodiment, after the first-type client identifier in the switching request is obtained, it can be determined whether the preset verification list includes the first-type client identifier (i.e., whether the first-type client identifier is in the preset verification list). When the preset verification list includes the first-type client identifier, Step 103 can be performed. That is, the first-type client is a legitimate client, and has a permission to switch the function mode.

When the preset verification list does not include the first-type client identifier, the process of switching function mode can be ended. That is, the first-type client is an illegitimate client, and does not have the permission to switch function mode.

In one embodiment, before switching function mode, the verification list can be set first. The verification list can include client identifier(s). In various embodiments, the client identifiers in the verification list include identifiers of legitimate clients. That is, only clients corresponding to the client identifiers in the verification list can have a right to access the group relationship. In various embodiments, the right to access the group relationship can include the permission to switch function mode. Thus, clients corresponding to the client identifiers that are not in the verification list cannot switch function mode. For example, when a user is an administrator of a voice room under a certain function mode, and the administrator under the function mode is allowed to switch function mode, the user can thus be a legitimate client, and can accordingly correspond to a client identifier in the verification list.

According to various disclosed embodiments, an original channel for connecting a server with each of a first-type client and a second-type client can be maintained. A switching request can be received from the first-type client via the original channel. At the same time, function-mode-configuration parameters can be sent to the first-type client and the second-type client via the original channel, such that the first-type client and the second-type client can update a function-mode-display interface according to the function-mode-configuration parameters. Because communication via the original channel can be maintained and unchanged, even if clients send a large number of requests to the server simultaneously, congestion will not occur during client-server interactions. Thus, server performance can be improved. Efficiency of switching function mode can be improved, and user's waiting time for the switching can be reduced.

Further, in one embodiment, before switching function mode, a verification method can be provided. Illegitimate users can be effectively identified, and security of switching function mode can be ensured.

In one embodiment, the disclosed method for switching function mode can be applied to a group-chat software program. In this case, a group relationship can include a room (i.e., a chat room, or a voice room) in the group-chat software program. The first-type client can be an administrator in the room, i.e., a room owner. The second-type client can be a general user in the room. There can be totally n general users (e.g., U1, U₂, U₃, U₄, U₅ . . . Uₙ) in the room. Only the administrator can have the right to initiate the switching of function mode.

In practical applications, the administrator and the general user in the room can stay connected to a server via a channel (i.e., an original connection channel, e.g., an established socket connection), and can perform various operations including, e.g., chatting. First, when the administrator initiates a switching request (or a function mode switching request), the administrator can select a function mode by clicking on a function selection field at a top right corner of a room interface. The room interface can be an interface being displayed under a certain function mode, e.g., a voice room interface under the function mode before switching function mode.

For example, FIG. 3 depicts an exemplary interface (e.g., room interface) illustrating an administrator initiating a function mode switching request in accordance with various disclosed embodiments. In one embodiment, the room interface shown in FIG. 3 can be a function-mode-display interface displayed on a terminal corresponding to the first-type client (e.g., the administrator), under a current function mode. In this example, the administrator can select from function modes including stage mode, squad mode, and host mode. The identifiers of the function modes can include names of the function modes (e.g., as shown in FIG. 3, stage mode, squad mode, and host mode) or any other suitable forms of identifiers. Name, meaning and configuration of each mode, and total number of function modes can vary based on needs of actual applications, without limitation. In various embodiments, under any one of the function modes, the room interface displayed respectively on the terminals corresponding to the first-type client and the second-type client can be the same or different, without limitation.

Different function modes can have different function-mode-configuration parameter(s). In various embodiments, the function-mode-configuration parameter(s) can include parameters indicating user's rights to perform certain actions, based on the user's role under the function mode. For example, under the host mode, only certain users (e.g., host) can speak in a voice room, and other users cannot speak. Only certain host and administrator can send text/image information in a voice room, and other users cannot do the same. Only the administrator has the right to switch function mode in this case. However, under the squad mode, all users may speak, but an administrator can allow a user to speak or prohibit a user from speaking. Only the administrator has the right to switch function mode in this case.

Next, the server can receive the switching request for a target function mode sent by the administrator via the original connection channel. Optionally, the server can verify the first-type client identifier that sends the switching request, determine whether the switching of function mode is legitimate, and proceed when the switching of function mode is legitimate.

The server can then obtain function-mode-configuration parameters corresponding to the target function mode. At the same time, the administrator and the general user(s) in the room can be in a waiting state. A waiting interface can thus be displayed during the waiting state. In various embodiments, under any one of the function modes, the waiting interface displayed respectively on the terminals corresponding to the first-type client and the second-type client can be the same or different, without limitation.

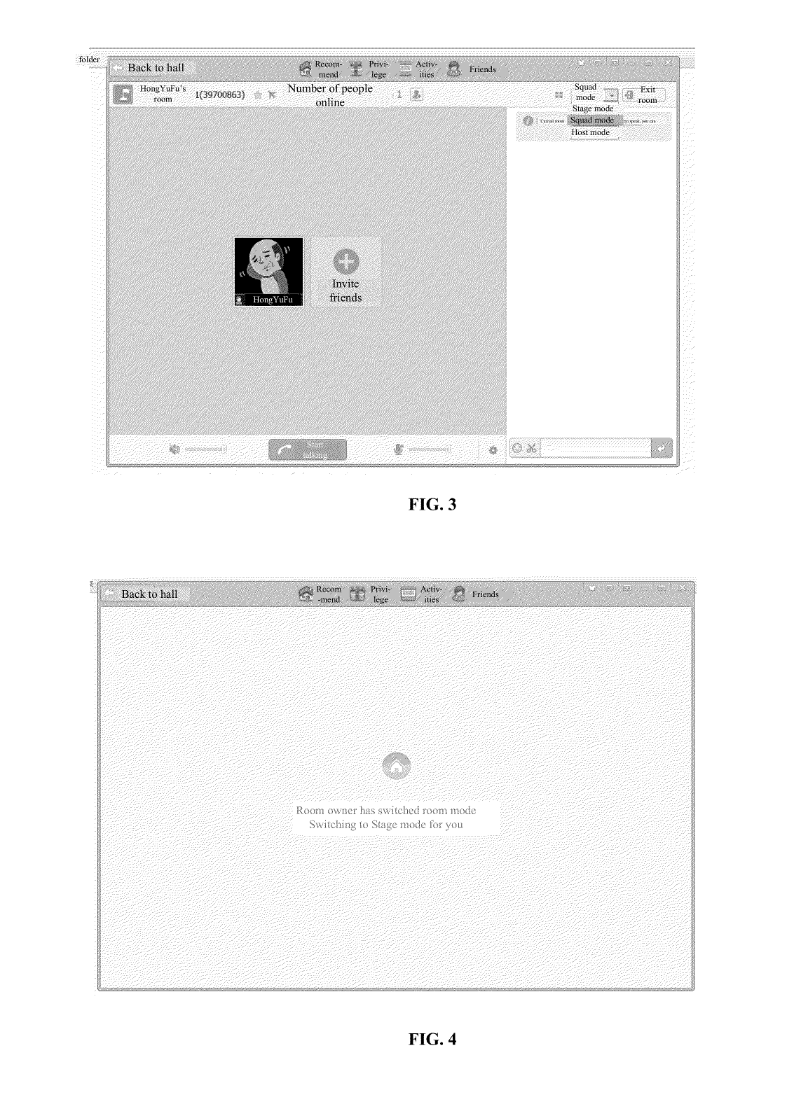

For example, FIG. 4 depicts an exemplary waiting interface during a process of switching function mode in accordance with various disclosed embodiments. In the example shown in FIG. 4, the waiting interface indicates that the room owner (i.e., the first-type client) has switched the room mode (i.e., the function mode) and that the function mode is being switched to stage mode. In this example, stage mode is the target function mode. The exemplary waiting interface can be displayed on the terminals of the first-type client and/or the second-type client.

In various embodiments, the server can then send the function-mode-configuration parameters and the target function mode to all the users in the current room. For example, the server can then send the function-mode-configuration parameters to the administrator and the general users (e.g., U1, U₂, U₃, U₄, U₅ . . . Uₙ) via the channel, such that the administrator and the general users can update a function-mode-display interface (or a display interface, or interface) according to the function-mode-configuration parameters.

That is, after the administrator and the general user receive the function-mode-configuration parameters and the target function mode from the server, the administrator and the general user can reset current function-mode-configuration parameters using the received function-mode-configuration parameters, and can then update and display the function-mode-display interface. In various embodiments, under any one of the function modes, the function-mode-display interface displayed respectively on the terminals corresponding to the first-type client and the second-type client can be the same or different, without limitation.

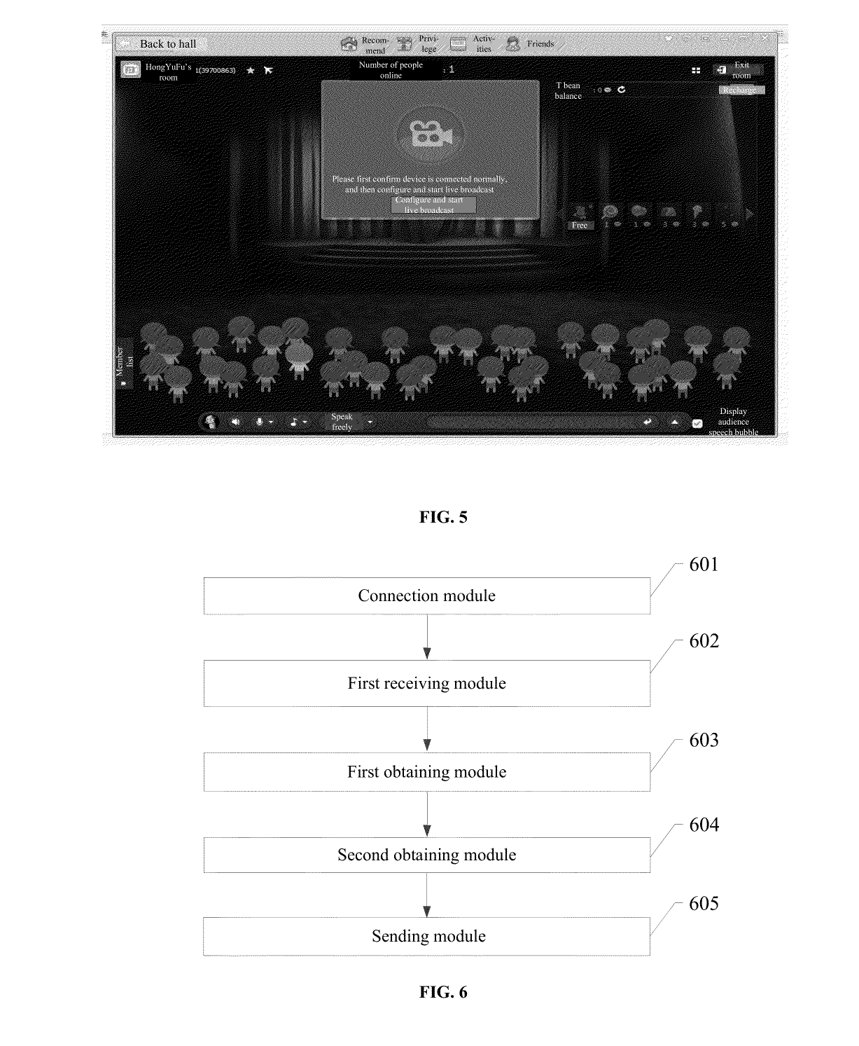

For example, FIG. 5 depicts an exemplary function-mode-display interface after successfully switching function mode in accordance with various disclosed embodiments. In the example shown in FIG. 5, the function-mode-display interface depicts an image of stage and audience, to indicate the stage mode. Optionally, a prompt can be displayed for the user to check device connection and to start communication under the target function mode. In certain applications, the communication may be configured and referred to as a live broadcast, a webcast, etc. The exemplary function-mode-display interface can be displayed on the terminals of the first-type client and/or the second-type client.

Accordingly, communications between the administrator and the general user(s) can be completed via the original channel. Even if a large number of client-server interactions take place simultaneously, congestion will not occur. Thus, server performance can be improved. Efficiency of switching function mode can be improved, and user's waiting time for the switching can be reduced.

FIG. 6 depicts a structure diagram of an exemplary apparatus for switching function mode in accordance with various disclosed embodiments. In various embodiments, the exemplary apparatus can be implemented by a computer system including, e.g., a server computer. The apparatus can include a connection module 601, a first receiving module 602, a first obtaining module 603, a second obtaining module 604, and/or a sending module 605. Certain modules may be omitted and other modules may be added.

The connection module 601 is configured to stay connected with each of a first-type client and a second-type client via a channel. The first receiving module 602 is configured to receive a switching request for a target function mode from the first-type client via the channel. The switching request can include a first-type client identifier and a target-function-mode identifier.

The first obtaining module 603 is configured to obtain a second-type client identifier corresponding to the first-type client identifier according to a preset group relationship, and then to obtain the second-type client corresponding to the second-type client identifier. The group relationship can include a correspondence relationship between the first-type client identifier and the second-type client identifier.

The second obtaining module 604 is configured to obtain function-mode-configuration parameter(s) corresponding to the target-function-mode identifier, according to a preset function-mode list. The function-mode list can include correspondence relationship(s) between function-mode identifiers and the function-mode-configuration parameter(s).

The sending module 605 is configured to send the function-mode-configuration parameters to each of the first-type client and the second-type client via the channel, such that the first-type client and the second-type client can update a function-mode-display interface according to the function-mode-configuration parameters.

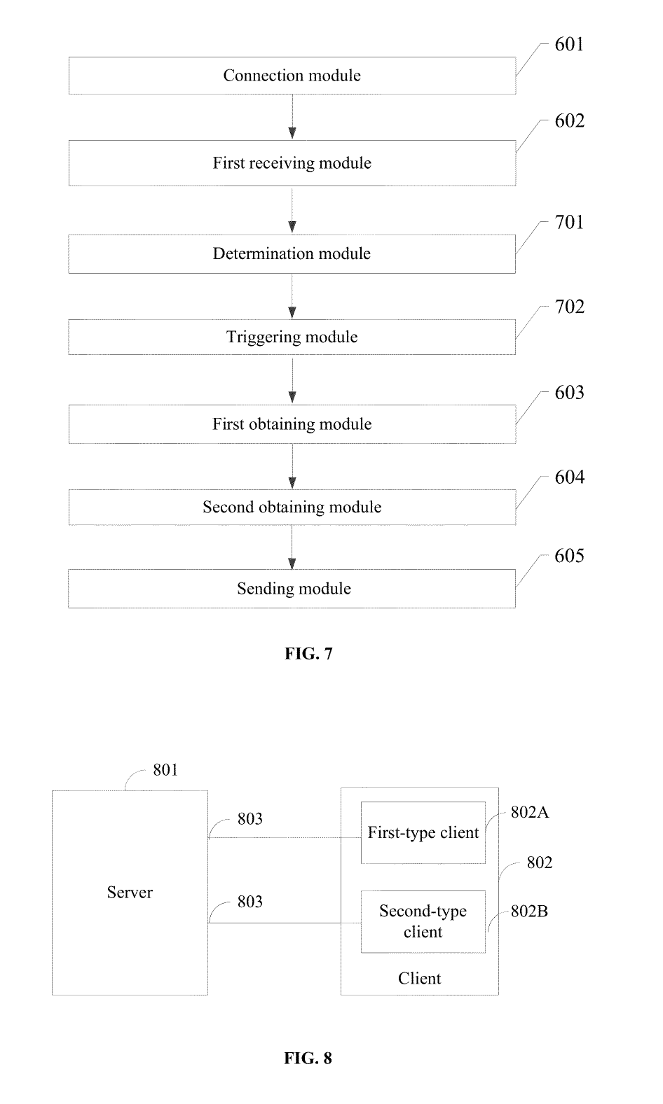

In order to prevent illegitimate users from switching function mode illegitimately, and to ensure security of switching function mode, in one embodiment, a function to verify the first-type client identifier that sends the switching request can be included. For example, FIG. 7 depicts a structure diagram of another exemplary apparatus for switching function mode including a verification function in accordance with various disclosed embodiments. In this example, in addition to the modules as depicted in FIG. 6, the exemplary apparatus in FIG. 7 can include a determination module 701 and/or a triggering module 702.

The determination module 701 is configured to determine whether a preset verification list includes the first-type client identifier. The verification list can include one or more client identifiers. The triggering module 702 is configured to trigger the first obtaining module 603 when the verification list includes the first-type client identifier.

According to various disclosed embodiments, an original channel for connecting a server with a first-type client and/or a second-type client can be maintained. A switching request can be received from the first-type client via the original channel. At the same time, function-mode-configuration parameters can be sent to the first-type client and the second-type client via the original channel, such that the first-type client and the second-type client can update a function-mode-display interface according to the function-mode-configuration parameters. Because communication via the original channel can be maintained and unchanged, even if clients send a large number of requests to the server simultaneously, congestion will not occur during client-server interactions. Thus, server performance can be improved. Efficiency of switching function mode can be improved, and user's waiting time for the switching can be reduced.

Further, before switching function mode, a verification function can be provided. Illegitimate users can be effectively identified, and security of switching function mode can be ensured.

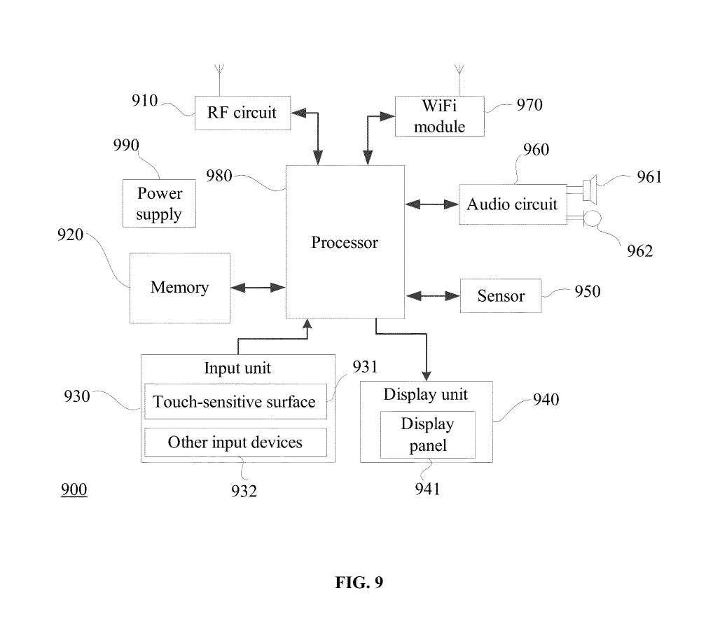

FIG. 8 depicts a structure diagram of an exemplary system for switching function mode in accordance with various disclosed embodiments. The system can include a server 801 and one or more clients 802. The clients 802 can include one or more first-type clients 802A and/or one or more second-type clients 802B. The server 801 can be connected with the first-type client 802A and the second-type client 802B via a channel 803.

The clients 802 can be implemented on terminals. The server 801 and the terminals may be coupled through a communication network for information exchange, sending/receiving switching request, sending receiving function-mode-configuration parameters, etc. Although only one server 801 and two clients 802 (i.e., the first-type client 802A and the second-type client 802B) are shown in FIG. 8, any number of clients 802 or servers 801 may be included, and other devices may also be included. The communication network may include any appropriate type of communication network for providing network connections to the server 801 and the clients 802 or among multiple servers 801 or clients 802. For example, the communication network may include the Internet or other types of computer networks or telecommunication networks, either wired or wireless. The network connections provided by the communication network can include the channel 803.

The server 801 is configured to receive a switching request for a target function mode from the first-type client 802A via the channel 803. The switching request can include a first-type client identifier and a target-function-mode identifier.

The server 801 is further configured to obtain a second-type client identifier corresponding to the first-type client identifier according to a preset group relationship, and then to obtain the second-type client 802B corresponding to the second-type client identifier. The group relationship can include a correspondence relationship between the first-type client identifier and the second-type client identifier.

The server 801 is further configured to obtain function-mode-configuration parameter(s) corresponding to the target-function-mode identifier, according to a preset function-mode list. The function-mode list can include correspondence relationship(s) between function-mode identifiers and the function-mode-configuration parameter(s).

The server 801 is further configured to send the function-mode-configuration parameters to the first-type client 802A and the second-type client 802B via the channel 803. The first-type client 802A and the second-type client 802B are configured to update a function-mode-display interface according to the function-mode-configuration parameters.

In order to prevent illegitimate users from switching function mode illegitimately, and to ensure security of switching function mode, in one embodiment, a function to verify the first-type client identifier that sends the switching request can be included. For example, the server 801 can further be configured to determine whether a preset verification list includes the first-type client identifier. When the verification list includes the first-type client identifier, the server 801 can be configured to obtain the second-type client identifier corresponding to the first-type client identifier according to the preset group relationship. In practical applications, for example, the system can be applied to group-chat software program.

Various embodiments also provide a computer system. The server and/or the terminal as disclosed herein can be implemented on the computer system in accordance with various disclosed embodiments. For example, FIG. 9 depicts a structure diagram of an exemplary computing system (or computer system) in accordance with various disclosed embodiments. The computer system can be configured to implement the methods as depicted in accordance with various disclosed embodiments.

When a server is implemented on the computer system, the server can refer to one or more server computers configured to provide certain server functionalities, e.g., receiving request from client, inquiring data, sending data, etc. A server may also include one or more processors to execute computer programs in parallel. When a terminal is implemented on the computer system, the terminal may refer to any terminal devices, e.g., mobile phones, tablet computers, personal digital assistants (PDAs), point of sales (POS), and/or onboard computers. The computer system in FIG. 9 can be used to implement any other suitable devices, without limitation. In one example, for illustrative purposes, the terminal can be a mobile phone and the computer system as depicted in FIG. 9 can include a mobile phone incorporating the methods according to various disclosed embodiments.

As shown in FIG. 9, the computer system 900 can include a radio frequency (RF) circuit 910, a memory 920 including one or more computer-readable storage media, an input unit 930, a display unit 940, a sensor 950, an audio circuit 960, a wireless fidelity (WiFi) module 970, a processor 980 including one or more processing cores, a power supply 990, and/or other components. The structure of the computer system depicted in FIG. 9 is for illustrative purposes only and does not limit the computer system. More or less components (e.g., as illustrated in FIG. 9) can be included, certain components can be combined, and arrangements of the components can be different.

The RF circuit 910 can be used to receive and transmit signals during receiving of information and during communication (e.g. chatting). For example, the RF circuit 910 can be configured to receive base station downlink information to send the same to the processors 980 for processing, and further, to send data related to uplink to the base station. Generally, the RF circuit 910 can include, but is not limited to, antenna, at least one amplifier, a tuner, one or more oscillators, subscriber identity module (SIM) card, transceiver, coupler, low noise amplifier (LNA), and duplexer. In addition, the RF circuit 910 can communicate with network and other devices via a wireless communication. The wireless communication can use any communication standard or protocol including, but not limited to, Global System of Mobile (GSM) communication, General Packet Radio Service (GPRS), Code Division Multiple Access (CDMA), Wideband Code Division Multiple Access (WCDMA), Long Term Evolution (LTE), e-mail, and Short Messaging Service (SMS).

The memory 920 is configured to store software programs and/or modules. By running or executing the software programs and/or modules stored in the memory 920, and by retrieving data stored in the memory 920, the processor 980 can perform various functions of the terminal/server (e.g., the mobile phone) and process data. The memory 920 may include a storage program area and a storage data area. The storage program area is configured to store operating systems and application programs required by one or more functions (e.g., sound playback, image playback, etc.) or any other suitable programs for storing. The storage data area is configured to store data created based on usage of the terminal/server (e.g., audio data, phone book, etc.). Further, the memory 920 can include high-speed random access memory (RAM) and/or non-volatile memory, e.g., one or more disk storage devices, flash memory devices, and/or other volatile solid-state memory devices. Accordingly, the memory 920 may also include a memory controller to provide the processor 980 with access to the memory 920.

The input unit 930 can be configured to receive inputted numbers or character information, and to generate signal input (e.g., by a keyboard, mouse, joystick, optical or trackball signal input) related to user settings and functional control of the computer system 900 (e.g., a mobile phone). For example, in one embodiment, the input unit 930 may include a touch-sensitive surface 931, and/or other input devices 932. The touch-sensitive surface 931, also known as a touch screen or touch panel, can be configured to collect touch operations by a user on or near the touch-sensitive surface 931 (e.g., operations on or near the touch-sensitive surface 931 from the user by using finger(s), a stylus, and/or any other suitable objects or accessories), and to drive corresponding connected apparatus according to preset programs. Optionally, the touch-sensitive surface 931 may include two parts including a touch detection apparatus and a touch controller. The touch detection apparatus is configured to detect the user's touch position, detect a signal generated by the touch operation, and send the signal to the touch controller. The touch controller is configured to receive touch information from the touch detection apparatus, convert it into contact point coordinates, send the coordinates to the processor 980, and receive commands sent by the processor 980 for executing. Furthermore, the touch-sensitive surface 931 can be implemented using various types including, e.g., a resistive, capacitive, infrared, and/or surface acoustic wave type. In addition to the touch-sensitive surface 931, the input unit 930 may further include other input devices 932 including, but not limited to, a physical keyboard, function keys (e.g., volume control keys, switch keys, etc.), trackball, mouse, and/or joystick.

The display unit 940 is configured to display information entered by the user, information provided for the user, or various graphical user interfaces of the computer system (e.g., various menus on the mobile phone). The graphical user interfaces can be formed by graphics, text, icons, videos, or a combination thereof. The display unit 940 may include a display panel 941, optionally, configured using liquid-crystal display (LCD), organic light-emitting diode (OLED) and/or any other suitable display methods. Further, the touch-sensitive surface 931 can cover the display panel 941. When the touch-sensitive surface 931 detects a touch operation on or near the touch-sensitive surface 931, the touch-sensitive surface 931 can process the touch operation to generate data, and send the data to the processor 980 to determine the type of the touch event. The processor 980 can then provide a corresponding visual output on the display panel 941, according to the type of the touch event. Although the touch-sensitive surface 931 and the display panel 941 are depicted in FIG. 9 as two separate components to achieve input and output functions, in various embodiments, the touch-sensitive surface 931 can be integrated with the display panel 941 for the input and output functions.

The computer system (e.g., the mobile phone) can further include one or more sensors 950 including, e.g., light sensor, motion sensor, and/or other sensors. For example, the light sensor may include an ambient light sensor and/or a proximity sensor. The ambient light sensor can adjust brightness of the display panel 941 according to the brightness of ambient light. The proximity sensor can turn off the display panel 941 and/or backlighting when the computer system is moved to be close to ear. As a type of motion sensor, an acceleration sensor may detect magnitude of acceleration in each direction (e.g., three-axis), and can detect magnitude and direction of gravity when still. Thus, the acceleration sensor can be configured for applications of identifying mobile phone postures (e.g., switching between horizontal and vertical screens, related games, magnetometer posture calibration), functions related to vibration recognition (e.g., pedometer, percussion), etc. The computer system can also be configured with gyroscope, barometer, hygrometer, thermometer, infrared sensor and other sensors.

The audio circuit 960, coupled with a speaker 961, a microphone 962 can provide an audio interface between the user and the computer system. The audio circuit 960 is configured to transmit to the speaker 961 an electrical signal after a conversion from received audio data. The speaker 961 is configured to convert the electrical signal to audio signal output. On the other hand, the microphone 962 is configured to convert collected audio signal to an electrical signal. The audio circuit 960 can receive the electrical signal for converting to audio data. The audio circuit 960 can output the audio data to the processor 980 for processing, and the processed audio data can be sent to another computer system (e.g., mobile phone) via the RF circuit 910. Alternatively, the audio data can be outputted to the memory 920 for further processing. The audio circuit 960 may also include an earphone jack to provide communication between a peripheral headset and the computer system.

WiFi is a short-range wireless transmission technology. The computer system can receive/send e-mail, browse web pages, and access streaming media, etc., via the WiFi module 970. The WiFi module 970 can be configured to provide wireless broadband Internet access. Although the WiFi module 970 is depicted in FIG. 9, it is not essential to the computer system 900, and can be omitted according to practical applications, without limitation.

The processor 980 can be a control center of the computer system, and can be configured to connect various components of the computer system using various interfaces and circuits. By running or executing software programs and/or modules stored in the memory 920, and by retrieving data stored in the memory 920, the processor 980 can be configured to perform various functions of the computer system and process data in order for an overall control of the computer system (e.g., mobile phone). Optionally, the processor 980 may contain one or more processing cores. Optionally, the processor 980 may integrate an application processor and a modem processor. The application processor can be configured to mainly process operating systems, user interfaces and application programs, etc. The modem processor can be configured to mainly process wireless communications. Optionally, the modem processor is not integrated into the processor 980.

The computer system can further include a power supply or power supplies 990 (e.g., a battery), to supply electric power to various components. Optionally, the power supply 990 can be connected to logic of the processor 980 via a power management system, and thus achieve functions including, e.g., charge/discharge management, power consumption management, etc. The power supply 990 may further include any other suitable components, e.g., one or more DC or AC power supplies, re-charging system, power failure detection circuit, power converter or inverter, power status indicator, and/or any other suitable components.

Although not shown in FIG. 9, the computer system can further include at least one camera, Bluetooth module, etc. In various embodiments, the processor 980 in the computer system can execute one or more application programs stored in the memory 920 according to the following instructions, in order to achieve various functions.

A server can stay connected with a first-type client and a second-type client via a channel. The server can receive a switching request for a target function mode from the first-type client via the channel. The switching request can include a first-type client identifier and a target-function-mode identifier. Optionally, the channel can include a socket connection.

After obtaining a second-type client identifier corresponding to the first-type client identifier according to a preset group relationship, the second-type client corresponding to the second-type client identifier can be obtained. The preset group relationship can include a correspondence relationship between the first-type client identifier and the second-type client identifier.

According to a preset function-mode list, function-mode-configuration parameter(s) corresponding to the target-function-mode identifier can be obtained. The function-mode list can include correspondence relationship(s) between function-mode identifiers and the function-mode-configuration parameter(s).

The function-mode-configuration parameters can then be sent to the first-type client and the second-type client via the channel, such that the first-type client and the second-type client can update a function-mode-display interface according to the function-mode-configuration parameters.

Optionally, after the receiving of the switching request for the target function mode from the first-type client via the channel, and before the obtaining of the second-type client identifier corresponding to the first-type client identifier according to the preset group relationship, the method can further include determining whether the first-type client identifier is in a preset verification list. The verification list can include one or more client identifiers. When the verification list includes the first-type client identifier, the second-type client identifier corresponding to the first-type client identifier can be obtained according to the preset group relationship. The second-type client corresponding to the second-type client identifier can then be obtained.

According to various disclosed embodiments, an original channel for connecting a server with a first-type client and a second-type client can be maintained. A switching request can be received from the first-type client via the original channel. At the same time, function-mode-configuration parameters can be sent to the first-type client and the second-type client via the original channel, such that the first-type client and the second-type client can update a function-mode-display interface according to the function-mode-configuration parameters. Because communication via the original channel can be maintained and unchanged, even if clients send a large number of requests to the server simultaneously, congestion will not occur during client-server interactions. Thus, server performance can be improved. Efficiency of switching function mode can be improved, and user's waiting time for the switching can be reduced.

Further, before switching function mode, a verification function can be provided. Illegitimate users can be effectively identified, and security of switching function mode can be ensured.

The apparatus disclosed herein can implement the methods as disclosed in various embodiments. The apparatus described above according to various embodiments are merely illustrative. The units/modules depicted as separate components may be or may not be physically separated. Components shown as units/modules may be or may not be physical units. That is, the components may be located in one place or may be distributed to multiple network units. According to practical needs, part or all of the units/modules can be selected to achieve the purpose according to various embodiments.

In the present disclosure, terms including, e.g., first, second, etc. are merely used to distinguish one entity/operation from another entity/operation, and do not necessarily require or imply any relationship or order existing between the entities/operations. Terms such as “comprising”, “including”, “containing” and any other variations thereof, are intended for non-exclusive inclusion, such that a process, method, article, or device that includes a series of elements can not only include the elements, but also include other elements that are not expressly listed and/or inherent elements included in such process, method, article, or device. Without further limitations, an element limited by a statement of “including a . . . ” does not exclude additional identical elements that may exist in the process, method, article, or device that includes the element.

The embodiments disclosed herein are exemplary only. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

The disclosed methods, apparatus and systems can be used in a variety of Internet applications. By using the disclosed methods, apparatus, and systems, an original channel for connecting a server with each of a first-type client and a second-type client can be maintained. A switching request can be received from the first-type client via the original channel. At the same time, function-mode-configuration parameters can be sent to the first-type client and the second-type client via the original channel, such that the first-type client and the second-type client can update a function-mode-display interface according to the function-mode-configuration parameters.

Thus, there is no need to re-establish a connection channel for switching a function mode. Because communication via the original channel can be maintained and unchanged, even if clients send a large number of requests to the server simultaneously, congestion will not occur during client-server interactions. Thus, server performance can be improved. Efficiency of switching function mode can be improved, and user's waiting time for the switching can be reduced.

Further, before switching function mode, a verification method can be provided to prevent illegitimate users from switching function mode illegitimately. Thus, illegitimate users can be effectively identified, and security of switching function mode can be ensured.

What is claimed is:

1. A method for switching a function mode, implemented by a computer system, comprising:
staying connected with each of a first-type client and a second-type client via a channel, wherein the each of the first-type client and the second-type client has a function-mode-display interface being displayed thereon;
receiving a switching request for a target function mode from the first-type client via the channel, wherein the switching request includes a first-type client identifier and a target-function-mode identifier;
obtaining a second-type client identifier corresponding to the first-type client identifier according to a preset group relationship, wherein the preset group relationship includes a correspondence relationship between the first-type client identifier and the second-type client identifier;
obtaining the second-type client corresponding to the second-type client identifier;
obtaining a function-mode-configuration parameter corresponding to the target-function-mode identifier according to a preset function-mode list, wherein the preset function-mode list includes a correspondence relationship between the target-function-mode identifier and the function-mode-configuration parameter; and
sending the function-mode-configuration parameter to the each of the first-type client and the second-type client via the channel, such that the each of the first-type client and the second-type client update the function-mode-display interface according to the function-mode-configuration parameter.

2. The method according to claim 1, wherein, after the receiving of the switching request and before the obtaining of the second-type client identifier, the method further includes:
determining whether the first-type client identifier is in a preset verification list, wherein the preset verification list includes one or more client identifiers; and
when the first-type client identifier is in the preset verification list, proceeding to obtain the second-type client identifier corresponding to the first-type client identifier according to the preset group relationship and to obtain the second-type client corresponding to the second-type client identifier.

3. The method according to claim 1, wherein the channel includes a socket connection.

4. The method according to claim 1, wherein the preset group relationship is applied to a group-chat software program.

5. An apparatus for switching a function mode, comprising:
a connection module configured to stay connected with each of a first-type client and a second-type client via a channel, wherein the each of the first-type client and the second-type client has a function-mode-display interface being displayed thereon;
a first receiving module configured to receive a switching request for a target function mode from the first-type client via the channel, wherein the switching request includes a first-type client identifier and a target-function-mode identifier;
a first obtaining module configured to:
obtain a second-type client identifier corresponding to the first-type client identifier according to a preset group relationship, wherein the preset group relationship includes a correspondence relationship between the first-type client identifier and the second-type client identifier; and
obtain the second-type client corresponding to the second-type client identifier;
a second obtaining module configured to obtain a function-mode-configuration parameter corresponding to the target-function-mode identifier according to a preset function-mode list, wherein the preset function-mode list includes a correspondence relationship between the target-function-mode identifier and the function-mode-configuration parameter; and
a sending module configured to send the function-mode-configuration parameter to the each of the first-type client and the second-type client via the channel, such that the each of the first-type client and the second-type client update the function-mode-display interface according to the function-mode-configuration parameter.

6. The apparatus according to claim 5, further including:
a determination module configured to determine whether the first-type client identifier is in a preset verification list, wherein the preset verification list includes one or more client identifiers; and
a triggering module configured to trigger the first obtaining module when the first-type client identifier is in the preset verification list.

7. The apparatus according to claim 5, wherein the channel includes a socket connection.

8. The apparatus according to claim 5, wherein the preset group relationship is applied to a group-chat software program.

9. A system for switching a function mode, comprising:
a server staying connected with each of a first-type client and a second-type client via a channel, wherein the each of the first-type client and the second-type client has a function-mode-display interface being displayed thereon, and the server is configured to:
receive a switching request for a target function mode from the first-type client via the channel, wherein the switching request includes a first-type client identifier and a target-function-mode identifier;
obtain a second-type client identifier corresponding to the first-type client identifier according to a preset group relationship, wherein the preset group relationship includes a correspondence relationship between the first-type client identifier and the second-type client identifier;
obtain the second-type client corresponding to the second-type client identifier;
obtain a function-mode-configuration parameter corresponding to the target-function-mode identifier according to a preset function-mode list, wherein the preset function-mode list includes a correspondence relationship between the target-function-mode identifier and the function-mode-configuration parameter; and
send the function-mode-configuration parameter to the each of the first-type client and the second-type client via the channel, such that the each of the first-type client and the second-type client update the function-mode-display interface according to the function-mode-configuration parameter.

10. The system according to claim 9, wherein the server is further configured to:
determine whether the first-type client identifier is in a preset verification list, wherein the preset verification list includes one or more client identifiers; and
when the first-type client identifier is in the preset verification list, proceed to obtain the second-type client identifier corresponding to the first-type client identifier according to the preset group relationship and to obtain the second-type client corresponding to the second-type client identifier.

11. The system according to claim 9, wherein the channel includes a socket connection.

12. The system according to claim 9, wherein the preset group relationship is applied to a group-chat software program.
